(19) United States
(12) Patent Application Publication
(10) Pub. No.: US 2025/0342492 A1
(43) Pub. Date: Nov. 6, 2025

(54) SYSTEMS AND METHODS FOR PREDICTING SERVICE DEMAND BASED ON GEOGRAPHICALLY ASSOCIATED EVENTS

(71) Applicant: Predict HQ Limited, Central Auckland (NZ)

(72) Inventors: Campbell Brown, Auckland (NZ); Xuxu Wang, Auckland (NZ); Robert Kern, South Head (NZ); Ali Gazala, Auckland (NZ)

(73) Assignee: Predict HQ Limited, Central Auckland (NZ)

(21) Appl. No.: 19/193,460

(22) Filed: Apr. 29, 2025

Related U.S. Application Data
(63) Continuation of application No. 17/598,578, filed on Sep. 27, 2021, now abandoned.

(30) Foreign Application Priority Data
Mar. 29, 2019 (NZ) 752220
Jul. 19, 2019 (NZ) 755601

(51) Int. Cl. G06Q 30/0201; G06Q 10/0631

(52) U.S. Cl. CPC G06Q 30/0206; G06Q 10/06315; G06Q 30/0201

(57) ABSTRACT

Techniques for predicting an impact of one or more events on service demand are disclosed. Some embodiments include first and second sets of data characterising properties of historic events using metadata tags, and demand for services that are then filtered to distinguish ordinary demand from extra-ordinary demand. Machine learning is used to determine correlations between metadata tags and extra-ordinary demand to produce a third data set operable for predictive determinations of future event impact on service demand.

### CROSS-REFERENCE TO RELATED APPLICATIONS

This application is a Continuation of U.S. patent application Ser. No. 17/598,578 filed Sep. 27, 2021, which is the National Stage of International Application No. PCT/NZ2020/050032, filed Mar. 30, 2020, which are entirely incorporated herein by reference.

### FIELD OF THE INVENTION

The present disclosure relates data analytics, and more particularly relates to analysis of big data sets to determine patterns and predict impact on local service demand based on the scheduling of future events.

### BACKGROUND TO THE INVENTION

Organizations typically accumulate large amounts of data, with different data created for different purposes and by different sources. Data intelligence involves analysis of that data for purposes such as big data analytics. Even if portions of data storage and organization may be automated, a user typically reviews the data, draws extrapolations and conclusions, then makes imprecise manual approximations and assumptions. However, big data is not processed efficiently by a human operator. Therefore, there is a demand for automation of data processing to determine future impact.
In the service industry, for example, the airline and hospitality industries, a service provider will typically offer services at a price. However, in periods of high demand, the service provider may be able to improve their revenues by increasing the price of services they offer, or increasing the capacity to offer their services. However, periods of high demand are not readily apparent, and usually only become apparent when spikes in service purchase is observed. By the time a reaction to an observed spike is made, significant revenue could be missed.
It is therefore an object of the present invention to predict high periods of service demand such that services offered for sale can be priced accordingly, and/or service capacity increased, or at least provide the public with a useful choice. Alternative objects will be apparent from the following disclosure.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY OF THE INVENTION

According to some broad embodiments the invention relates to a computer-implemented method of predicting service demand changes from events geographically associated with the service; the method comprising:

providing historical service demand information;

receiving by the computer a request to determine outlier service demand information;

receiving by the computer a request to determine event characteristics attributable to the outlier service demand information;

determining by the computer a prediction for a future service demand outlier a future event;

providing by the computer to the user the determination of the future service demand outlier; wherein the computer predicts the future direction of service demand for the requested event and provides that prediction to the user so that the user can decide whether to offer more, or less service capacity based on the prediction of the future direction of the service demand.

In some embodiments, the event characteristics attributable to the outlier service demand information comprises at least one of:
weather facts: e.g., autumn, spring, dry season, wet season
region of an event: e.g., central America, Middle Africa, Northern Europe
duration of an event
city location of an event
event category: e.g., conferences, expos, sports
event label: e.g., technology conference, soccer sports
PHQ rank
PHQ local rank

In another broad aspect the invention consists in a method of controlling at least one of price or capacity of a service offering, comprising:
a. receiving a first set of data comprising properties of one or more historic events in a geographically limited region, each event having a temporal factor;
b. characterising properties of each of the one or more historic events into metadata tags;
c. receiving a second set of data relating to a demand for one or more services located within the geographically limited region, the demand for services having a temporal factor;
d. receiving a service data set relating to at least one of price or capacity of at least one service product offering;
e. receiving a third data set comprising metadata tags characterising a future event, and
f. filtering the demand for one or more services to thereby distinguish ordinary demand from extra-ordinary demand;
g. determining, by machine learning, a correlation between metadata tags, or combinations of metadata tags, and extra-ordinary demand, then quantifying the impact of the correlation, the impact having a binary characterisation;
h. producing a third data set comprising a grouping of metadata tags, or combinations of metadata tags, associated with events having impact quantified above a threshold, wherein the third dataset is operable for predictive determinations of future event impact on service demand; and
h. determining, by machine learning, a prediction model relating metadata tags, or combinations of metadata tags of the third data set to extra-ordinary demand;
i. calculating the measure of impact of the future event on the service by application of the prediction model to the future event data set; then
j. altering data defining at least one of the price or capacity offering of the service provider based on the calculated measure of impact.

In another broad aspect the invention consists in a method of predicting event impact on service demand, comprising:
a. receiving a first set of data comprising properties of one or more historic events in a geographically limited region, each event having a temporal factor;
b. characterising properties of each of the one or more historic events into metadata tags;
c. receiving a second set of data relating to a demand for one or more services located within the geographically limited region, the demand for services having a temporal factor;
d. filtering the demand for one or more services to thereby distinguish ordinary demand from extra-ordinary demand;
e. determining, by machine learning, a correlation between metadata tags, or combinations of metadata tags, and extra-ordinary demand, then quantifying the impact of the correlation, the impact having a binary characterisation;
f. producing a third data set comprising a grouping of metadata tags, or combinations of metadata tags, associated with events having impact quantified above a threshold, wherein the third dataset is operable for predictive determinations of future event impact on service demand; and
k. determining, by machine learning, a prediction model relating metadata tags, or combinations of metadata tags of the third data set to extra-ordinary demand.

In some embodiments, the method further comprises predicting a measure of impact a future event will have on the service, comprising:
l. receiving an event data set comprising metadata tags characterising a future event; and
m. calculating the measure of impact of the future event on the service by application of the prediction model to the future event data set.

In some embodiments, the method further comprises:
n. altering service provider capacity based on the calculated measure of impact.

In some embodiments, the method further comprising configuring an automated service provider booking platform, the booking platform in control of at least one of price, or capacity, to: receive data indicative of the determined measure of impact; and altering at least one of price or capacity in response to the determined measure of impact.

In some embodiments, the step of altering at least one of price or capacity comprises applying the measure of impact to a scale, and the magnitude of altering corresponds to the scale.

In some embodiments, the metadata tags are a selection of tags stored in a library of tags.

In some embodiments, the filtering to distinguish ordinary demand comprises: time series modelling of demand over time to identify a repeating demand characteristic representative of daily, weekly, monthly, and/or seasonal service use.

In some embodiments, filtering to distinguish extra ordinary demand comprises: identifying one or more instances of magnitude of demand which exceeds the repeating demand.

In some embodiments, extra ordinary demand is determined by:
determining a regular temporal pattern of demand for one or more service providers; and
determining one or more measures of demand exceeding a threshold above the regular temporal pattern.

In some embodiments, the data relating to a magnitude of demand for one or more services comprises data representing passengers arriving at a transit hub.

In some embodiments, a geographically limited region comprises a geographical region comprising the geographical location of an event and the geographical location of a transit hub.

In some embodiments, the transit hub is an airport, and the geographically limited region comprises a region encompassing the event the closest airport.

In another broad aspect the invention consists in a system for controlling at least one of price or capacity of a service offering, the system comprising:
one or more databases that store:
a. a first set of data comprising properties of one or more historic events in a geographically limited region, each event having a temporal factor; and
b. a second set of data relating to a demand for one or more services located within the geographically limited region, the demand for services having a temporal factor;
c. a service data set relating to at least one or price or capacity of at least one service product offering;
d. a third data set comprising metadata tags characterising a future event, and an analysis unit configured to:
e. characterise properties of each of the one or more historic events into metadata tags;
f. filters the demand for one or more services to thereby distinguish ordinary demand from extra-ordinary demand;
g. determine, by machine learning, a correlation between metadata tags, or combinations of metadata tags, and extra-ordinary demand, then quantifying the impact of the correlation, the impact having a binary characterisation;
h. store a third data set in a further database, the third dataset comprising a grouping of metadata tags, or combinations of metadata tags, associated with events having impact quantified above a threshold, wherein the third dataset is operable for predictive determinations of future event impact on service demand;
o. determine, by machine learning, a prediction model relating metadata tags, or combinations of metadata tags of the third data set to extra-ordinary demand;
p. receive an event data set comprising metadata tags characterising a future event; and
q. calculate the predicted measure of impact of the future event on the service by application of the prediction model to the future event third data set; then
r. alter the service provider capacity based on the calculated measure of impact.

In another broad aspect the invention consists in a system for predicting event impact on service demand, comprising:
one or more databases that store:
a. a first set of data comprising properties of one or more historic events, each event having a temporal factor; and
b. a second set of data relating to a demand for one or more services the demand for services having a temporal factor; and
an analysis unit configured to:
c. characterise properties of each of the one or more historic events into metadata tags;
d. filters the demand for one or more services to thereby distinguish ordinary demand from extra-ordinary demand;
e. determine, by machine learning, a correlation between metadata tags, or combinations of metadata tags, and extra-ordinary demand, then quantifying the impact of the correlation, the impact having a binary characterisation;
f. store a third data set in a further database, the third dataset comprising a grouping of metadata tags, or combinations of metadata tags, associated with events having impact quantified above a threshold, wherein the third dataset is operable for predictive determinations of future event impact on service demand; and
s. determine, by machine learning, a prediction model relating metadata tags, or combinations of metadata tags of the third data set to extra-ordinary demand.

In some embodiments, the system further comprises a database that stores:
a third data set comprising metadata tags characterising a future event, and
the analysis unit is further configured to:
receive an event data set comprising metadata tags characterising a future event;
calculate the predicted measure of impact of the future event on the service by application of the prediction model to the future event third data set.

In some embodiments, the analysis unit is further configured to:
Indicate an alteration to the service provider capacity based on the calculated measure of impact.

In some embodiments, the analysis unit is further configured to instruct an automated service provider booking platform, the booking platform in control of at least one of price, or capacity, to: receive data indicative of the determined measure of impact; and
alter at least one of price or capacity in response to the determined measure of impact.

In some embodiments, altering at least one of price or capacity comprises applying the measure of impact to a scale, and the magnitude of altering corresponds to the scale.

In some embodiments, the metadata tags are a selection of tags stored in a library of tags.

In some embodiments, the analysis unit is further configured to:
apply a time series model of demand over time to identify a repeating demand characteristic representative of daily, weekly, monthly, and/or seasonal service use to thereby distinguish ordinary demand.

In some embodiments, the analysis unit is further configured to:
identify one or more instances of magnitude of demand which exceeds the repeating demand to thereby distinguish extra ordinary demand.

In some embodiments, the analysis unit is further configured to:
determine a regular temporal pattern of demand for one or more service providers; and
determine one or more measures of demand exceeding a threshold above the regular temporal pattern to thereby determine extra ordinary demand.

In some embodiments, the data relating to a magnitude of demand for one or more services comprises data representing passengers arriving at a transit hub.

In some embodiments, a geographically limited region comprises a geographical region comprising the geographical location of an event and the geographical location of a transit hub.

In some embodiments the transit hub is an airport and the geographically limited region comprises a region encompassing the event the closest airport.

In another broad aspect the invention consists in a non-transitory computer-readable storage medium storing instructions that, when executed by a computer process, cause a computing device to:
receive a first set of data comprising properties of one or more historic events in a geographically limited region, each event having a temporal factor;
characterise properties of each of the one or more historic events into metadata tags;
receive a second set of data relating to a demand for one or more services located within the geographically limited region, the demand for services having a temporal factor;
filter the demand for one or more services to thereby distinguish ordinary demand from extra-ordinary demand;
determine by machine learning, a correlation between metadata tags, or combinations of metadata tags, and extra-ordinary demand, then quantifying the impact of the correlation, the impact having a binary characterisation;
produce a third data set comprising a grouping of metadata tags, or combinations of metadata tags, associated with events having impact quantified above a threshold, wherein the third dataset is operable for predictive determinations of future event impact on service demand; and
determine, by machine learning, a prediction model relating metadata tags, or combinations of metadata tags of the third data set to extra-ordinary demand.

In another broad aspect the invention consists in a method of predicting event impact on service demand, comprising:
a. receiving a first set of data carrying information on properties of one or more historic events, each event having a temporal factor;
b. characterising the properties of each of the one or more historic events into metadata tags;
c. receiving a second set of data carrying information on demand for one or more services, the demand for services having a temporal factor;
d. filtering the demand for one or more services to thereby distinguish ordinary demand from extra-ordinary demand;
e. identifying, by machine learning, a correlation between i) metadata tags, or combinations of metadata tags, of given historical events and ii) extra-ordinary demand for a service, then quantifying the impact of the correlation, the impact having a binary characterisation;
f. producing a third data set identifying grouping of metadata tags associated with events having impact quantified above a threshold, wherein the third dataset is operable for predictive determinations of future event impact on service demand; and
k. determining, by machine learning, a prediction model relating metadata tags of the third data set to extra-ordinary demand.

In another broad aspect the invention consists in a method of generating data predicting demand on a service dependent on data on future events, comprising:
a. receiving historic event data carrying information describing one or more historic events;
b. characterising each of the one or more historic events using a set of metadata tags defined for the method to describe the historic events with metadata tags operable upon by one or more machine learning processes used by the method;
c. receiving demand data carrying information on historic demand for one or more services;
f. filtering the historic demand data for one or more services into ordinary demand and extra-ordinary demand for the service;
g. generating correlation data identifying metadata tags or combinations of metadata tags that have a quantifiable impact on extraordinary demand where the impact is quantified using two or more machine learning models and the metadata tags identified in the correlation data have an impact quantified above a threshold;
d. receiving service data carrying information on at least one of price or capacity of at least one service to be controlled;
e. receiving a future-event data carrying information on properties which characterise a future event,
h. characterising each of the one or more future events using the set of metadata tags defined for the method to describe the future events with metadata tags operable upon by one or more machine learning processes used by the method;
i. using a further one or more machine learning models operating on metadata tags of the future events to generate demand predicting data carrying information on a metric for future demand for the service, where the metadata tags are those identified in the correlation data.

The method may comprise the step of providing property grouping data carrying information on a grouping of properties, or combinations of metadata tags, associated with events having impact quantified above a defined threshold and determining the prediction model dependent on the property grouping data.

The method may comprise a step of generating data carrying information on a measure of impact of the future event on demand for the service by application of the prediction model to the third data characterising the future event.

The method may comprise a step of altering data, or generating data indicating an alteration, or generating data defining at least one of the price or capacity offering of the service provider based on the measure of impact of the future event on demand.

In some embodiments, the invention relates to any one or more of the above statements in combination with any one or more of any of the other statements. Other aspects of the invention may become apparent from the following description which is given by way of example only and with reference to the accompanying drawings.

The entire disclosures of all applications, patents and publications, cited above and below, if any, are hereby incorporated by reference. This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 illustrates graph showing an example of what is a typical flight booking curve for any given flight to a destination;

FIG. 2 illustrates graph showing another example of flight booking curve;

FIG. 3 illustrates a computing system suitable for executing embodiments of one or more software modules that perform analyses related to prediction of services demand impacted by an event;

FIG. 4 outlines a process according to one embodiment whereby data relating to a number of historic events is gathered and interpreted to determine a relationship between those events and impact on service demand;

FIG. 5 shows an exemplary process implementation of steps, where event data sources are received by the computer;

FIG. 6 illustrates graphs showing the number of people booked on flights to a particular destination airport for a time span of several weeks; and

FIG. 7 shows an exemplary selection of real airline travel data, in particular, passengers travelling to a particular destination airport.

### DETAILED DESCRIPTION OF THE INVENTION

Exemplary methods and systems are described herein. It should be understood that the word “exemplary” is used herein to mean “serving as an example, instance, or illustration.” Any embodiment or feature described herein as “exemplary” or “illustrative” is not necessarily to be construed as preferred or advantageous over other embodiments or features. More generally, the embodiments described herein are not meant to be limiting. It will be readily understood that certain aspects of the disclosed systems and methods can be arranged and combined in a wide variety of different configurations, all of which are contemplated herein.

The term “and/or” referred to in the specification and claim means “and” or “or”, or both. The term “comprising” as used in this specification and claims means “consisting at least in part of”. When interpreting statements in this specification and claims which include that term, the features, prefaced by that term in each statement all need to be present but other features can also be present. Related terms such as “comprise” and “comprised” are to be interpreted in the same manner.

The term “system” referred to in the specification and claims may comprise software, hardware, or a combination thereof. For example, the software can be machine code, firmware, embedded code, and application software. Also for example, the hardware can be circuitry, processor, computer, integrated circuit, integrated circuit cores, active or passive sensors or sensing equipment, or a combination thereof.

The term “user” referred to in the specification and claims refers to an individual such as a person, or a group or people, or a business such as a retailer or advertiser of one or more a products or services. The primary meaning of “user” referred to in the specification and claims is the recipient of video and/or audio sources. However, “user” may also refer to provider of video or audio sources.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Many of the functional units described in this specification have been labelled as modules, in order to more particularly emphasize their implementation independence. For example, a module may be implemented as a hardware circuit specialized circuits, gate arrays, purpose specific semiconductors such as preprogramed for function microprocessors, logic chips, transistors, or other discrete components, or a combination of these components. A module may also be implemented in programmable hardware devices such as field programmable gate arrays, programmable array logic, programmable logic devices or other similar devices.

Modules may also be implemented in software for execution by various types of processors. An identified module of executable code may, for instance, comprise one or more physical or logical blocks of computer instructions which may, for instance, be organized as an object, procedure, or function. Further, an identified module need not be physically located together, but may comprise disparate instructions stored in different locations which, when joined logically together, comprise the module and achieve the stated purpose for the module.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing. More specific (non-exhaustive) examples of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a magnetic disk, a magnetic storage device, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on a user computer, partly on a user computer, as a stand-alone software package, partly on a user computer and partly on a remote computer or entirely on the remote computer or server. In the latter scenario, a remote computer may be connected to a user's computer through any type of network, including a local area network (LAN) or a wide area network (WAN), or the connection may be made to an external computer, for example, through the Internet using an Internet Service Provider.

Further, the term network is generally used to describe a means through which data is transported from one location or module to another. In this context, the network may equally include the transportation of data by writing that data to a transportable form of computer readable storage media, and relocating that storage from one physical location to another.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

A software facility is described below that uses predictive information about events in order to assist in evaluating decisions related to the events in various ways, such as to assist service providers in evaluating service provision decisions which may be impacted by the events. In some exemplary embodiments, the predictive information is used by a service provider to understand the likelihood that service capacity they provide will be adequate to meet a likely demand and/or whether an advertised price for a service optimizes the benefit to the service provider. In such embodiments, a supplier of such an service may alter prices of a service, or the available capacity of a service or other conditions for the service based on the event date based on the date as the event approaches, such as to raise a price for the service such as to maximise profit based on last-minute demand, or such as to lower the price to attract buyers where capacity is unlikely to be filled. Any such actions taken by suppliers may in some embodiments be performed by the suppliers in a purely formulaic and repeatable manner (e.g., as an automated process). For example, the output of the software facility may be a number representing the impact an event is predicted to have on a service offering. That number may be interpreted by a service offering pricing algorithm which then responds accordingly to, for example, raise the price of a service or increase the service capacity predicted to be in demand due to the event. In other embodiments some subjective variability may be included with respect to such actions (e.g., based on manual input for or oversight of the actions).

When discussed herein, a supplier of a service includes an original supplier of an service and/or any other party involved in providing of the service who has control over or influence on the setting of a current price for the service before it becomes available to an acquirer (whether an intermediate service provider or an end-user customer), and may further in some situations include multiple such parties (e.g. multiple parties in a supply chain).

In particular, in some embodiments the predictive pricing for a service item is based on an analysis of historical information related to an event which had impact on demand for a service item and/or related items. Such historical pricing information analysis may in some embodiments automatically identify patterns in the service demand, such as temporal patterns of increased or decreased demand for a service. In addition, in some such embodiments the analysis further associates the service demand and/or service demand patterns with one or more related factors (e.g., factors that have a causal effect on the service demand or are otherwise correlated with the service demand), such as factors that are automatically identified in one or more of a variety of ways during the analysis. Furthermore, in some embodiments predictive service demand policies are also automatically developed based on other automatically identified predictive pricing information, such as to enable specific demand-related predictions for a particular event given specific current factors. Specific mechanisms for performing such predictive analysis are discussed in greater detail below.

When such predictive information is available for a future event, that information can then be used to assist providers of a related service in making better decisions related to scheduling of capacity and/or providing of capacity for their service. Events relating to embodiments discussed in this specification include events attended by people. In some cases, the event will be attended by people local to that event. In other cases, the event will be attended by people who are not local and must travel to the event. In some cases, events attended by non-local people will require services to be provided to support attendance of the event, for example, transportation of those people to and from the event, and accommodation of those people who attend the event. Examples of an event include any kind of social or public occasion which would cause a gathering of people such as concerts, conferences, sporting matches, entertainment shows and the like.

As one example, a service provider may in some embodiments use predictive information for future events to advise potential related service providers of those events in various ways. This advice may be in the form of generated data for indications or automated notifications. These may be for price or service provision, for example, or indicating adjustments in these. For example, when providing information relating to persons who are intending to attend an event, a notification may in some embodiments be automatically provided to providers of services local to that event to advise them in a manner based on predicted attendance for the event, such as whether the people are likely to travel to the event from local areas, from areas further afield, and what impact that might have on factors such as transportation required for those persons to reach the event (such as flight services, train services, taxi services), whether those persons will require accommodation (such as hotel services) or any other services which may be required by people who attend the event.

Such advice could further in some embodiments provide specific reasons for the provided advice, such as based on information about specific predicted future events (e.g., a specific predicted time and/or number of people who might attend the event, number of people who might travel to the event, what transportation services might be used by people attending the event, the number of people who might require accommodation around the time of the event), as well as additional details related to the advice (e.g., specific future conditions under which to make available service capacity, how much service capacity to offer).

In situations in which the potential service provider does not need to immediately offer their service and the predicted future event attendance indicates that the demand for services is likely to drop, for example, the potential service provider can use that information to determine to delay a service offering.

As one example, the service provider may in some embodiments use predictive demand information for services to advise potential event attendees of those services in various ways. For example, when providing pricing information for an item to a current customer, a notification may in some embodiments be automatically provided to the customer to advise the customer in a manner based on predicted future pricing information for the item, such as whether the current price is generally a “good buy” price given those predicted future prices, or more specifically whether to buy immediately due to predicted future price increases or to delay buying due to predicted future price drops. Such advice could further in some embodiments provide specific reasons for the provided advice, such as based on information about specific predicted future pricing information (e.g., a specific predicted direction, time and/or magnitude of a future price change, a specific predicted future price, etc.), as well as additional details related to the advice (e.g., specific future conditions under which to make an acquisition, such as a specific amount of delay to wait and/or a specific future price to wait for). In situations in which the potential buyer does not need to immediately make a purchase and the predicted future pricing information indicates that the price is likely to drop, for example, the potential buyer can use that information to determine to delay a purchase.

In particular, given information about current factors that are associated with the event attendance and the associated impact on the services of service providers, the predictive attendance information for the event can be used to make predictions about future event attendance for related services. Such future predicted event attendance can take various forms in various embodiments, including a likely changes of any future event attendance, a likely timing of when any changes to event attendance will occur, a likely magnitude of any event attendance changes, likely particular future event attendance, etc. In addition, in some embodiments the future predicted event attendance may further include predictions of the specific likelihood of one or more of such types of future event attendance. Moreover, in some embodiments and/or situations the predictive event attendance and/or services provided based on that information may be performed for a fee.

For illustrative purposes, some embodiments of the software facility are described below in which particular predictive service demand techniques are used for particular types of events, and in which available predictive service demand information is used to assist service providers and/or event attendees in various ways. However, those skilled in the art will appreciate that the techniques of the invention can be used in a wide variety of other situations, and that the invention is not limited to the illustrated types of events or service provider techniques or uses of predictive pricing information.

Some such service provider items with which the illustrated event attendance predictive techniques and/or uses of predictive event information include car rentals, hotel rentals, vacation packages, vacation rentals (e.g., homes, condominiums, timeshares, etc.), cruises, transportation (e.g., plane train, boat, etc.), gasoline, food products, jewellery, consumer electronics (e.g., digital and non-digital still and video cameras, cell phones, music players and recorders, video players and recorders, video game players, PDAs and other computing systems/devices, etc.), books, CDs, DVDs, video tapes, software, apparel, toys, electronic and board games, automobiles, furniture, tickets for movies and other types of performances, various other types of services, etc.

Furthermore, the disclosed techniques could further be used with respect to item-related information other than event attendance, whether instead of or in addition to event attendance information.

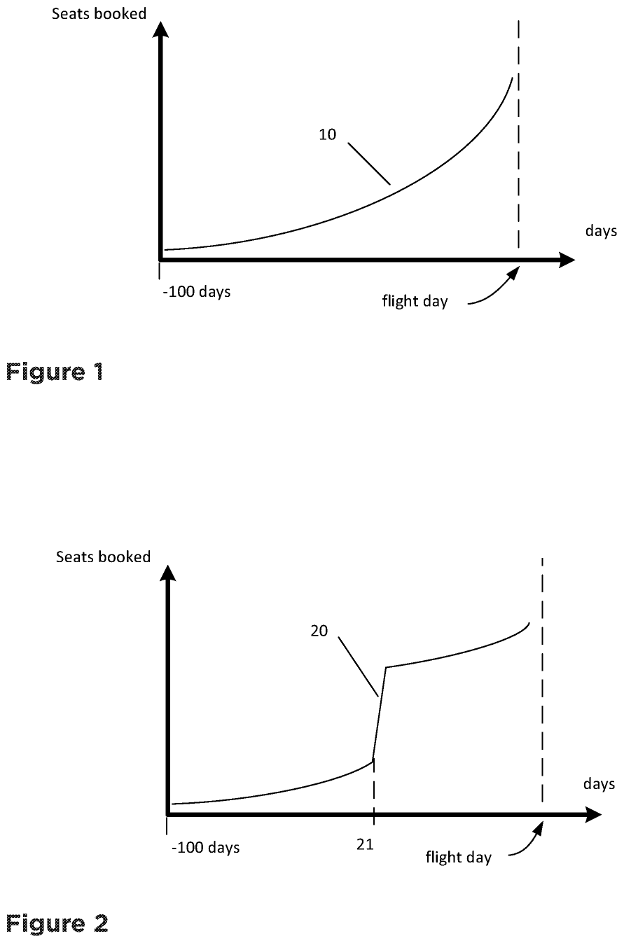

FIGS. 1-7 provide examples illustrating predictive service demand based on event information. In these examples, the predictive techniques are described as applied to flight information as are used by a provider of flight services, such as an airline for making decisions such as seat capacity (aircraft size) on any flight with a destination proximate a future event, or how many aircraft to schedule to fly to a particular destination proximate a future event and when to schedule those flights, and what price a seat on a flight could be. Such related decisions are often balanced against the available fleet of aircraft any given airline has, regular flight services, the ability to add flight capacity to a particular destination such as by changing the size of the plane and therefore the inherent seat capacity, and what price point remains competitive relative to other service providers.

In the exemplary context of a flight service provider, FIG. 1 illustrates graph showing an example of what is a typical flight booking curve for any given flight to a destination. That is, the number of seats booked from some arbitrary point in time (shown as from 100 days before the flight departure) on a flight leading up to the day of the flight. Typically the booking curve 10 exhibits exponential growth, but is largely smooth. The rate of seats booked increases as the date of flight departure approaches.

FIG. 2 illustrates graph showing another example of flight booking curve. However, this booking curve exhibits a sharp increase in the number of seats booked, indicated by the sharp incline 20. The point in time 21 at which the sharp incline occurs is indicative of an event occurring in the location of the flight destination airport and scheduled to take place at a time corresponding to the scheduled arrival of that flight.

As any given flight has a limited number of seats, the demand for seats on such a flight may cause that flight to sell out and the airline to miss the opportunity to generate additional revenue from providing additional capacity and/or higher ticket prices for that flight. Due to the competitive nature of flight pricing, airlines in particular are sensitive to items such as events increasing demand. Historically, airline flight pricing algorithms are reactive, meaning the airfare for a flight might be predetermined to increase in response to factors such as the frequency of seats booked on a flight, an increase in the number of purchased airfares scheduled to arrive at a certain time, and so on.

Airlines in particular recognise that algorithms responsive to such factors means lost revenue because some airfares must be purchased at regular prices before an increase in demand is recognised and the airfares adjusted accordingly. Therefore, service providers desire the ability to proactively identify events which are likely to have impact on service offerings without pre-existing service purchase data.

A historic issue with proactively determining the impact of future events on services is that there is no way to identify events which will cause impact, and for those that will, what level of impact those events might have. Accordingly, embodiments discussed herein describe methods for determining which events are likely to have the impact of future events on services, and what level that impact might be. Some embodiments relate to the characterisation of events occurring at a geographical location which may cause impact on the surrounding service industry.

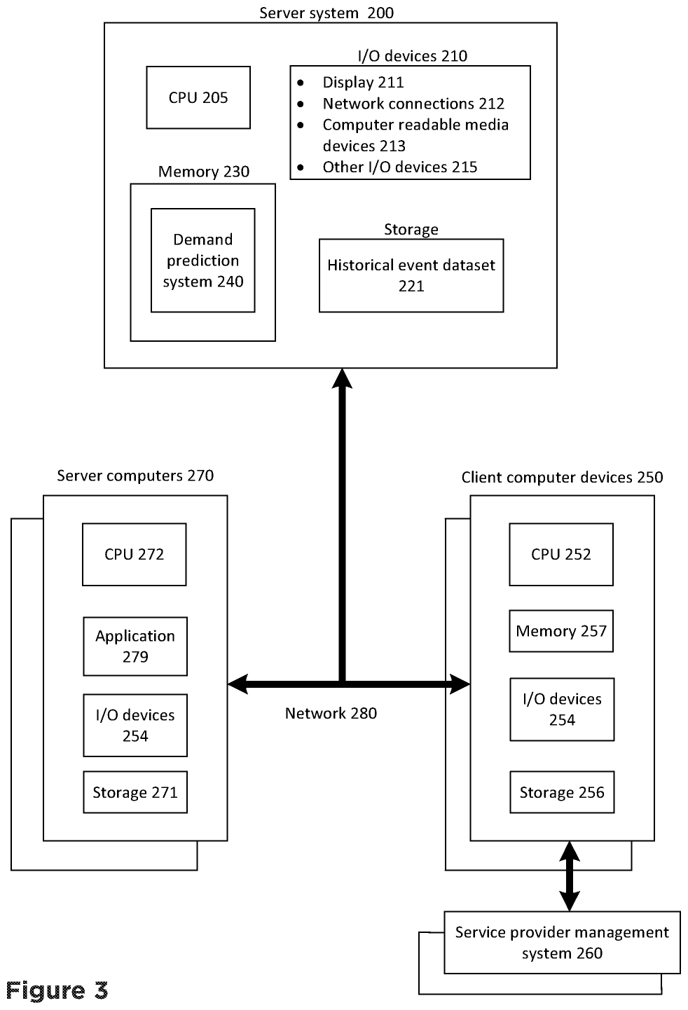

FIG. 3 illustrates a computing system 200 suitable for executing embodiments of one or more software modules that perform analyses related to prediction of services demand impacted by an event. The example computing system includes a CPU 205, various I/O devices 210, storage 220, and memory 230. The I/O devices include a display 211, a network connection 212, a computer-readable media drive 213, and other I/O devices 215.

A demand prediction system 240 executes in memory 230 in this example in order to analyse historical event related data and determine characteristics of an event which impact upon service demand. As the demand prediction system executes in memory 230, it analyses various historical service data, such as flight data, as may be available in a local database 221 in storage. Data may also be stored elsewhere such as from another executing system or remote storage location. After analysing the historical flight data at the request of a user or instead on a scheduled basis, the demand prediction system determines information from one or more events in the proximity of the flight destination airport related to the historical travel. That is, characteristics of the event that have had effect on the quantity of people travelling to a particular destination, various patterns or other information about travel relative to the event characteristics over at least a period of time scheduled for the event to take place.

The system then in the illustrated embodiment stores the determined information in a database 223 on storage, although in other embodiments the system could provide the information interactively to a user or other executing system. In some embodiments and/or situations, the demand prediction system could also obtain historical event and flight demand information for use in its analysis by repeatedly querying an external supplier of such information to obtain then-current information, and could then analyse the obtained information, whether dynamically as it is obtained or instead later after a sufficient amount of historical event and flight demand information has been gathered or on a periodic basis.

Such external information sources could be accessed in a variety of ways, such as via one or more server computers 270, and/or client computer systems 250 over a network 280 to retrieve stored information. For example, remote server computers 270 have a CPU 272 operating to process data received via one or more I/O devices 254. Data would be processed according to application instructions 279 stored in storage 271. One example of a remote located server might be a data centre constructed for receiving and processing data received directly from client computer systems 250. The remote server computers 270 may also be configured to perform some or all of the processing steps required for data processing. External information sources including client computer systems 250 could also be accessed directly to retrieve event data and service provider data. For example, one or more client computers 250 could have a CPU 252 executing instructions stored in memory 257, the instructions including gathering of data stored on the client computer system in storage 256 or accessed by a remotely connected service provider management system 260.

In this illustrated embodiment, the demand prediction system 240 provides predictive demand information to a request by obtaining information about the predicted impact an event will have on the items as discussed above, by analysing and modifying the obtained information if needed, and providing information about the predicted future demand on any one or more services.

In particular, as one example of a system facility that can obtain and use demand prediction information, the demand prediction system facility 240 is executing in memory 230. In response to an indication to provide advice, such as based on an interactive request from a customer (such as a service provider of items listed above) or instead based on a scheduled indication to determine whether to provide an alert to a customer based on a previously received request, the demand prediction system obtains predictive event demand information for one or more items, such as by interacting with the demand prediction system. The demand prediction system also obtains current event information for those items, and then determines one or more types of advice to provide to an appropriate customer based on that information.

In some embodiments, the advice is provided via notifications interactively displayed to the customer that indicate information about predicted demand on services to advise the customer. In other embodiments, the advice may be provided in other forms, such as via an alert sent to a registered customer. Various information about customers may be stored and used when providing advice, such as in a customer database, in order to determine when, whether, and how to provide notification to a customer in accordance with their preferences and interests.

The demand prediction system facility 247 can obtain and use event information in order to enable better service offering decisions, in this situation by directly assisting service providers. In particular, the system obtains demand prediction information for one or more items. The demand prediction system facility then assists the service provider in determining whether and when to make decisions, such as to advance or delay service offerings based on predicted future service demand drops and/or to aggregate service offerings together to provide additional benefits, to negotiate with any intermediate or associated parties, to immediately offer service items that are not otherwise immediately needed based on predicted future service demand increases, etc.

Those skilled in the art will appreciate that computing systems and devices 200, 250 and 270 are merely illustrative and are not intended to limit the scope of the present invention. Computing system 200 may be connected to other devices that are not illustrated, including through one or more networks such as the Internet or other computer network. More generally, a “client” or “server” may comprise any combination of hardware or software that can interact in the indicated manner, including computers, network devices, internet appliances, PDAs, wireless phones, pagers, electronic organisers, television-based systems and various other consumer products that include inter-communication capabilities. In addition, the functionality provided by the various system components may in some embodiments be combined in fewer components or distributed in additional components. Similarly, in some embodiments the functionality of some of the illustrated components may not be provided and/or other additional functionality may be available.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components may execute in memory on another device and communicate with the illustrated computing device via inter-computer communication. Some or all of the system components or data structures may also be stored (e.g., as instructions or structured data) on a computer-readable medium, such as a hard disk, a memory, a network, or a portable article to be read by an appropriate drive. The system components and data structures can also be transmitted as generated data signals (e.g., as part of a carrier wave) on a variety of computer-readable transmission mediums, including wireless-based and wired/cable-based mediums. Accordingly, the present invention may be practiced with other computer system configurations.

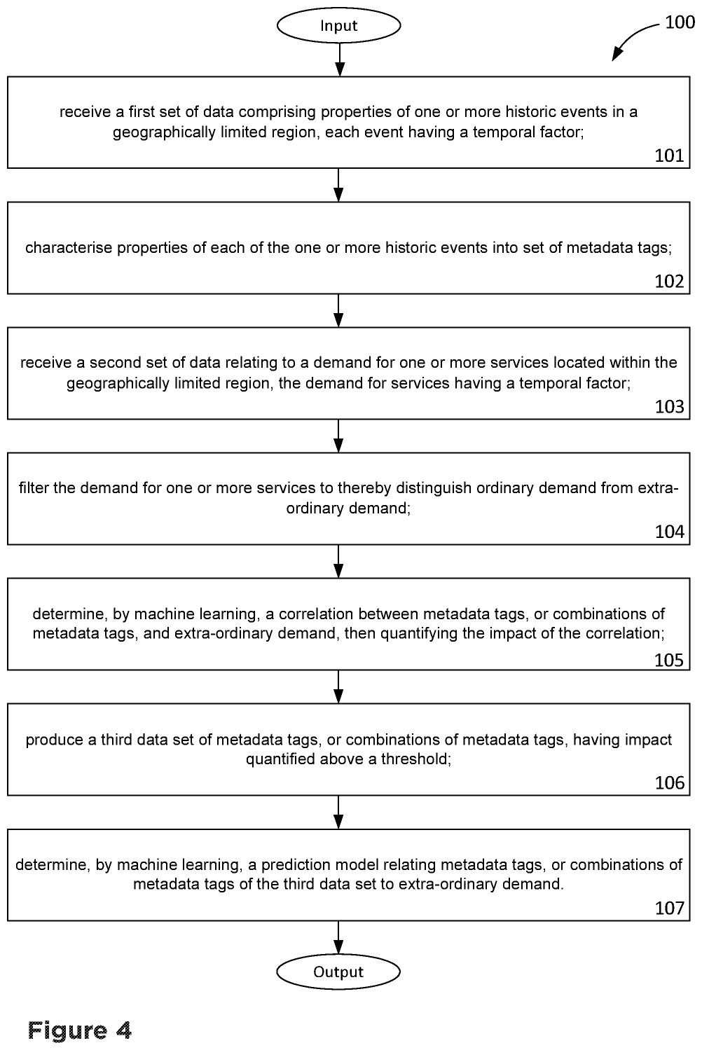

FIG. 4 outlines a process 100 according to one embodiment whereby data relating to a number of historic events is gathered and interpreted to determine a relationship between those events and impact on service demand. The process is implemented by a computer executing machine readable instructions, stored on a machine readable medium, to receive data, process that data, and generate an output indicative of an event which is likely to have an impact an on the services associated with that event.

The first steps of the process 100 are designed to identify characteristics of historic events which have had some impact on services. Those historic event events determined to have impact and then used to compile a new data set which is in turn used for predicting service demand increases which might be caused by future events.

Accordingly, a first step 101 requires that the computer is configured to receive data from event data sources. The data includes properties of one or more historic events. In some embodiments the data is from a geographically limited region, and/or has a temporal factor.

The temporal factor is data, or an attribute of data, which relates the time or time span of an event and the time at which an impact on services is most likely to occur. Here the time of an event is typically, though not exclusively, the intended time of an event. For example, a conference occurring on a Wednesday may have impact on travel or accommodation services on the prior Tuesday, Wednesday and Thursday and people travel to and from the location of the conference.

Similarly, the geographically limited region is intended to capture services local to the event. For example, if an event causes people to require air travel services, then the airport closest to the location of the event is deemed to be the mostly likely to require additional flight services for people flying to and from the event. Geographically limited region is therefore intended to mean a geographical region which encompasses at least the closest airport, or other major transportation hub servicing the event location.

Data relating to historic events may be retrieved from a variety of information sources including event schedules, online databases and/or third parties data providers. The form of data retrieved from each source is unlikely to be harmonised, and some events may be of a kind that are known to not impact service industries, such as online or virtual events, or spam events. Therefore the historic event data retrieved requires transformation, cleansing and enrichment.

At a second step 102, the computer is configured to characterise the properties of each of the one or more historic events according to metadata tags. The metadata tags are intended to be a harmonised set of data operable to generally characterise the historic event data. For example, raw event data received might generally include event title, time and location data, such as “Dentistry conference; Date; Time; and Address of conference location”. Metadata tags representing each data item can therefore be assigned to characterise each of the raw data items. In addition, additional metadata tags may be assigned to the event as part of a data enrichment process. Additional metadata may include data relating to:
weather facts: e.g., autumn, spring, dry season, wet season
region of an event: e.g., central America, Middle Africa, Northern Europe
duration of an event
city location of an event
event category: e.g., conferences, expos, sport; and
event label: e.g., technology conference, soccer sports.
   Many metadata items may be generated to characterise an event. Further, metadata enrichment may be added to a dataset retrospectively, for example in an instance where a new defining characteristic is identified as having impact on the accuracy of a prediction after initial predictions are determined.

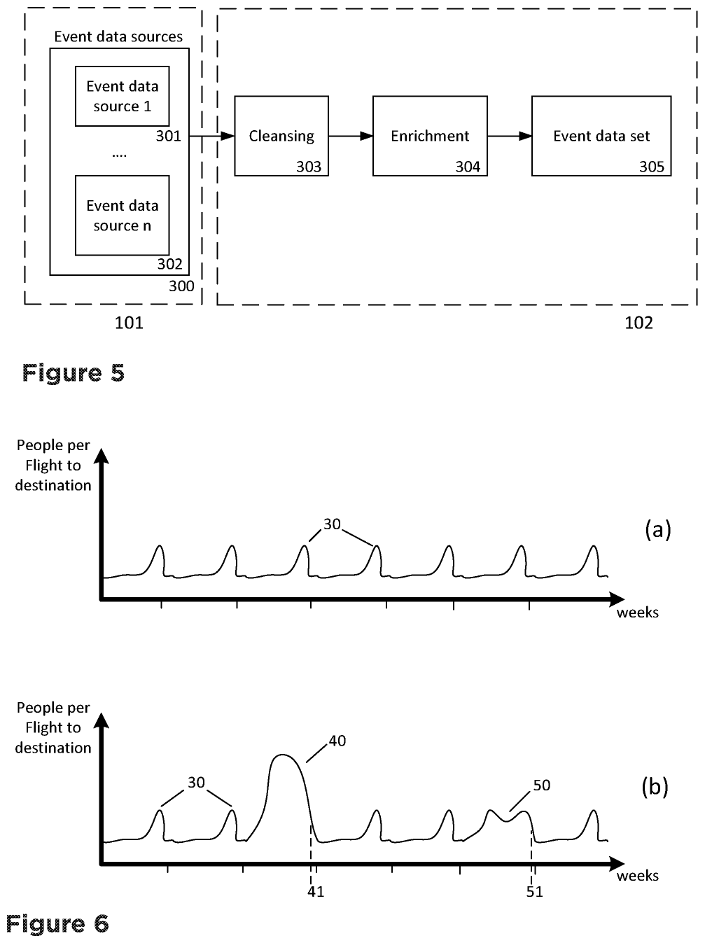

FIG. 5 shows an exemplary process implementation of steps 101 and 102, where event data sources 300, including many different event data sets 301, 302, are received by the computer. At a step 303, the raw data is cleansed to remove events or event data which is not relevant for predicting the impact on services in a geographical area proximate an event, such as virtual events which have no physical location. At step 304, enrichment of the data may take place to add additional metadata items. At step 305, an event data set containing metadata harmonised for each event in the dataset is produced for further processing.

Referring again to FIG. 4, at step 103 the process includes receiving a second set of data relating to a historic demand for one or more services located within the geographically limited region, the demand for services having a temporal factor. One example of the second set of data is airline flight schedule and passenger arrival information. Such information is widely logged, readily retrieved and accurately represented. Such information shows, for example, passengers booked on flights to a destination airport or arriving, or scheduled to arrive at the destination airport.

Graph (a) of FIG. 6 shows the number of people booked on flights to a particular destination airport for a time span of several weeks. This information will often exhibit fairly repetitive weekly patterns with peak travel times 30 generally aligning with weekend time periods. Where regular weekly or even monthly patterns are observable, an airline planning flight seat availability has a reasonable level of confidence that they understand the likely demand for flight services and can plan service capacity accordingly.

Graph (b) of FIG. 6 shows the number of people booked on flights to a particular destination airport where regular peaks 30 are observable. However, the regular travel pattern is interspersed with a period of time where significant additional travel 40 to a destination airport is observed. Also, the regular travel pattern is interrupted with a period of time 50 where a period of time which also shows a mild increase in planned travel to a destination. In the time period 40, the significant additional people per flight to a destination might be explained by an event scheduled to occur at time point 41 at the location proximate the destination airport. That event has caused more people to travel to that destination at that time than would be usually observable. In the time period 50, additional people per flight to a destination can also be observed which might also be explained by an event occurring at time point 51. However, the number of people impacting on the flights for each event is different. In the case of the event at 41, the additional travellers may prompt an airline to raise ticket prices or provide additional flight capacity in order to generate higher revenues from the greater than usual demand. Conversely, the additional travellers for the event at 51 may not warrant any additional action from the airline as it may be covered by existing service capacity.

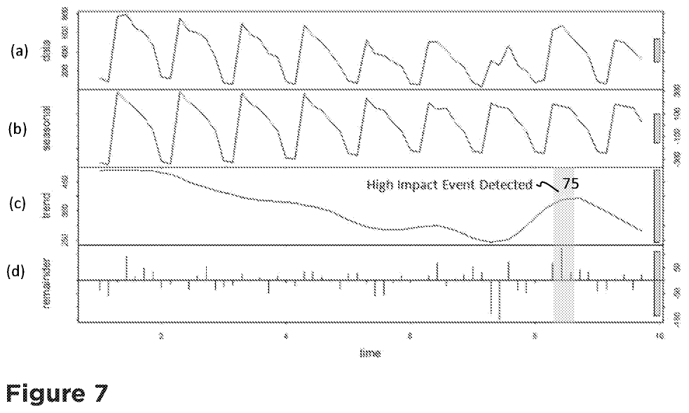

FIG. 7 shows an exemplary selection of real airline travel data, in particular, passengers travelling to a particular destination airport. FIG. 7(a) shows raw data of the number of passengers travelling each week to the destination with peaks generally coinciding with weekends. FIG. 7(b) shows seasonal data. FIG. 7(c) represents a trend of ordinary travel magnitude, exhibiting a downward trend until a spike in airline travel is observable time in region 75 which relates to extra-ordinary travel magnitude. FIG. 7(d) shows a representation of the daily difference between the trend of FIG. 7(c) and the raw passenger travel data. There is commonly some difference in daily data from the trend data, and this difference can be explained by ordinary circumstances, and may be statistically represented such as by a standard deviation in the trend analysis. However, region 75 indicates a large difference between ordinary travel magnitude and extra-ordinary travel magnitude, and this difference may be explained by an event located at or shortly after the date where the peak is observable.

Extracting the data shown by FIG. 7 involves developing a robust time-series solution to decompose cyclical (i.e. ordinary) and noncyclical (i.e. excessive or extra-ordinary) air travel patterns. To decompose this data, time-series processing techniques such as an ARIMA model, STL model and Rolling Windows-Based algorithms can be implemented. The time series modelling allows extraction of demand patterns that implicitly consider ordinary demand patterns such as seasonal demand patterns.

Referring again to FIG. 4, at step 104 the process includes filtering the demand for one or more services to thereby distinguish ordinary demand from extra-ordinary demand. As described above, ordinary demand can be identified by time-series modelling to compose regular cyclic travel patterns with seasonal trends, and extra-ordinary demand can be identified as deviations from the cyclic patterns and trends. In some embodiments, the particular deviation is compared to a threshold, and only when that threshold is exceeded is a high demand period determined. For example, a threshold representing 20% increase in service demand could represent an external influence, such as an event as having caused the identified impact.

At step 105, the process includes implementing a first machine learning process in order to identify any correlation between metadata tags, or combinations of metadata tags, associated with events in the event data set with extra-ordinary service demand which has been identified at step 104. In some embodiments, determining the correlation involves building a pipeline of machine learning models including Random Forest algorithms, Gradient Boosting Machines and Artificial neural network models that identify and quantify impact on service demand. For example, the models are optimised to estimate the impact of different travel purpose events, and specifically metadata tags of these, such as business conferences or entertainment music festival by establishing mathematical relationship patterns between events having particular metadata and historical service demand. According to preferred embodiments, the impact on service demand of given metadata tags or combinations of these of historic events is quantified as an output of the machine learning model. The quantification may be, for example, a number representing the fitment of the models are which are able to correlate the data sets. Many mathematical representations are possible.

At step 106, the process produces a third data set of metadata tags, or combinations of metadata tags, having impact quantified above a threshold. This step is performed by comparing to the mathematical representation of the fitment to a threshold. Where the representation is below the threshold, the event associated with the metadata tags is disregarded. Where the representation is exceeds the threshold, the third data set is produced from the metadata of those events. In this way, the third data set is produced from events which have been deemed to have at least some impact on service demand. For following processes, this step greatly improves the accuracy of determinations based on further machine learning processes, by reducing the amount of irrelevant, or inconsequential data from further consideration. This is equivalent to improving the signal to noise ratio of the impact determination process.

In some embodiments, prediction of service demand impact may be determined based on the third data set of events which are determined to have at least some impact on service demand. For example, one or more of price or capacity of a service offering could be increased in response to a future event determined to have impact on service demand based on a prediction model trained from the third data set. However, the prediction accuracy can be significantly improved by conducting further steps as will now be outlined.

At step 107, the process includes implementation of a second machine learning process to establish correlation between the events and associated metadata in the third data set established at step 106 and the and instances of extra-ordinary demand established at step 104. Again, determining the correlation involves building a pipeline of machine learning models including Random Forest algorithms, Gradient Boosting Machines and Artificial neural network models that identify and quantify impact on service demand. The output of step 107 is a machine learning model that is trained to correlate historic events with impact on services.

The model may then be applied to future events, characterised in the same manner as outlined with respect to FIG. 4. The output of the model is mathematical representation of the predicted impact of the future event on the related services the model was trained for. The mathematical representation may be best represented as a percentage representing an impact ranking.

In some embodiments, the impact ranking of the future event is determined by a process of receiving an event data set comprising metadata tags characterising a future event; and applying the prediction model to the event data set to thereby determine a measure of impact of the future event on the service.

Some embodiments are implemented using data which comprises properties of events by carrying information on properties of events.

Some embodiments are implemented using data which relates to demand by carrying information on the demand.

Some embodiments are implemented using grouping of metadata tags, combinations or metadata tags or other data dependent on stored rules. For example step 104 of FIG. 4 may be implemented with a rule which indicates demand data to be extraordinary if it is above 20%.

Some embodiments are implemented using data which defines associations between metadata tags, or combinations of metadata tags and events, such as events having impact quantified above a threshold.

Some embodiments are implemented by producing and/or providing data by generating data.

Some embodiments implement filtering demand for services by sorting data carrying information on the demand wherein the sorting is performed using stored rules.

In some embodiments ordinary demand and extraordinary demand are distinguished by grouping operations applied to demand data.

In various embodiments a temporal dependence or temporal characteristic for an event, demand or other information is implemented by data which can carry information which may vary over time.

In various embodiments information operations or steps involving a time factor may be implemented using time dependent data.

Various embodiments receipt of data may be implemented as being received from memory, a data store or various data facilities known to the reader.

Various embodiments of the invention described implement the processes, steps or operational modules illustrated herein such as filtering, sorting, and altering are implemented using stored rules.

In some embodiments a temporal factor for data or information carried in data is any temporal attribute of data or information relevant to given applications of the embodiments.

In some embodiments data carrying information on events or data carrying information on services may carry geolocation information or geographical information. This information may be used to select events or services. In some embodiments geographical features other than locations or physical proximity are described by geographical information of geographical limitations. For example, transit times to a location may be described by geographical information. In this example a geographically limited region may be limited by transit time to a location of a service, for example. Also for example, information describing transport links may be described by geographical information.

In some embodiments, the geographical information may be used with additional data carrying information on transport links or other infrastructure to select events or services. In these embodiments events or services may be selected using metrics that are dependent on the geographical data and other data for example, transit times may be used to select events or services.

In some embodiments the third dataset generated in step 106 of FIG. 4 identifies metadata tags that have an impact on demand as determined by machine learning operating on historic events characterised using a harmonised set of metadata tags and operating on instances of extra-ordinary demand for a service. In some embodiments it is these metadata tags, identified by the third data set, of the future events that are operated upon by the second machine learning of step 107 that are used to predict demand for a service. This means the metadata tags or combinations of metadata tags that correlate with extraordinary demand, as determined by machine learning operating on historic data, that are used to predict the impact of future events on future service demand.

In some embodiments a fitment of various machine learning models that are able to correlate metadata tags, or combinations of these, to demand for a service, is used to provide a predictive model. In some additional embodiments it is only events that are determined to have an impact on extraordinary demand that are operated on by the first machine learning process to identify metadata tags or combinations of these that correlate to demand for a service.

Various embodiments characterise events using a set of metadata tags. As described herein the set of metadata tags is harmonised. In some embodiments these harmonised metadata tags conform to a data model used by the method or system. In some embodiments the data model is instantiated as metadata tags to characterise a given event for which information is carried in data received by the method or system.

Preferably a service provider has a system configured to receive at least the measure of impact of the future event on the service. Based on the measure, the service provider system may be manually or automatically configured to respond to that measure. For example, the response may include application of the measure to a threshold, and when that threshold is met, the response may include increasing the price and/or capacity of the service offering. Further, the response may be proportional to the measure, with the increase in price or capacity commensurate with the level of the measure. The measure may be a number on a defined scale, such as a percentage or value in a defined range of values. Accordingly, the response made by a service provider system may be divided into ranges, where a value of the measure falling within a particular range enables a particular response. In some embodiments, the response is predetermined. In other embodiments, the response is based on an algorithm or mathematical function. For example, the response is derived from the value of the measure.

Those skilled in the art will also appreciate that in some embodiments the functionality provided by the routines discussed above may be provided in alternative ways, such as being split among more routines or consolidated into less routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

What we claim is:

1. A method of configuring an automated booking service platform comprising generating and storing data predicting event impact on service demand by steps, by one or more processors, comprising:
a. receiving a first set of data carrying information on properties of one or more historic events, each event having a temporal factor;
b. assigning metadata tags to each of the one or more historic events, by the one or more processors, to characterise each event using properties indicated by the metadata tags;
c. receiving a second set of data carrying information on demand for one or more services, by the one or more processors, the demand for services having a temporal factor;
d. filtering the data carrying information on demand for one or more services through performing grouping operations on the second set of data, by the one or more processors, to thereby distinguish ordinary demand from extra-ordinary demand and to identify extra-ordinary demand;
e. determining, through a first machine learning process executed by the one or more processors, a correlation between metadata tags, or combinations of metadata tags, and extra-ordinary demand identified in an event data set, then quantifying the impact of the correlation, the impact having a binary characterisation, wherein the metadata tags are associated with the events in the event data set with the extra-ordinary demand;
f. generating a third data set a third data set comprising a grouping of metadata tags, or combinations of metadata tags, associated with events having impact quantified above a threshold, by the one or more processors, wherein the third dataset is operable for predictive determinations of future event impact on service demand; and
g. implementing a second machine learning process, by the one or more processors, to determine, a prediction model relating metadata tags, or combinations of metadata tags of the third data set to extra-ordinary demand, thereby establishing a correlation between the events and associated metadata in the third data set;
h. generating data carrying information on a measure of impact of the future event on demand for the service through application of the prediction model to the third data characterising the future event, by the one or more processors; and
i. storing in a database the generated data carrying information on a measure of impact of the future event on demand.

2. The method of claim 1, wherein the method further comprising predicting a measure of impact a future event will have on the service, comprising:
receiving the event data set comprising metadata tags characterising a future event; and
calculating the measure of impact of the future event on the service by application of the prediction model to the future event data set.

3. The method of claim 1, wherein the method further comprises: altering service provider capacity based on the calculated measure of impact.

4. The method of claim 1, wherein the method further comprising configuring an automated service provider booking platform, the booking platform in control of at least one of price, or capacity, to:
receive data indicative of the determined measure of impact; and
alter at least one of price or capacity in response to the determined measure of impact.

5. The method of claim 1, wherein the step of altering at least one of price or capacity comprises applying the measure of impact to a scale, and the magnitude of altering corresponds to the scale.

6. The method of claim 1, wherein the metadata tags are a selection of tags stored in a library of tags.

7. The method of claim 1, wherein filtering to distinguish ordinary demand comprises:
time series modelling of demand over time to identify a repeating demand characteristic representative of daily, weekly, monthly, and/or seasonal service use.

8. The method of claim 1, wherein filtering to distinguish extra ordinary demand comprises: identifying one or more instances of magnitude of demand which exceeds a repeating demand.

9. The method of claim 1, wherein extra ordinary demand is determined by:
determining a regular temporal pattern of demand for one or more service providers; and
determining one or more measures of demand exceeding a threshold above the regular temporal pattern.

10. The method of claim 1, wherein the data relating to a demand for one or more services comprises data representing passengers arriving at a transit hub.

11. The method of claim 1, wherein the historic events and/or the services are in a geographically limited region encompasses the geographical location of an event and the geographical location of a transit hub.

12. The method of claim 1, wherein the historic events and/or the services are in a geographically limited region comprising and wherein the transit hub is an airport, and the geographically limited region comprises a region encompassing the event and the closest airport.

13. An automated booking service platform configured using generated and stored data carrying information predicting event impact on service demand, comprising:
one or more databases that store:
a. a first set of data carrying information on properties of one or more historic events, each event having a temporal factor; and
b. a second set of data carrying information on a demand for one or more services, the demand for services having a temporal factor; and
an analysis unit, comprising one or more processors coupled to the one or more databases, configured to:
a. assign metadata tags to each of the one or more historic events to characterise each event using properties indicated by the metadata tags;
b. filter the data carrying information on demand for one or more services by performing grouping operations on the second data set to thereby distinguish ordinary demand from extra-ordinary demand and to identify extra-ordinary demand;
c. implement a first machine learning process, by the one or more of processors to determine a correlation between metadata tags, or combinations of metadata tags, and extra-ordinary demand identified in an event data set, then quantifying the impact of the correlation, the impact having a binary characterisation, wherein the metadata tags are associated with the events in the event data set with the extra-ordinary demand;
d. generate and store a third data set in a further database, the third data set carrying information on a grouping of metadata tags, or combinations of metadata tags, associated with events having impact quantified above a threshold, wherein the third dataset is operable for predictive determinations of future event impact on service demand; and
e. implementing a second machine learning process, by the one or more of processors to determine a prediction model relating metadata tags, or combinations of metadata tags of the third data set to extra-ordinary demand identified, thereby establishing a correlation between the events and associated metadata in the third data set;
f. generate data carrying information on a measure of impact of the future event on demand for the service by application of the prediction model to the third data characterising the future event; and
g. store in a further database the generated data carrying information on a measure of impact of the future event on demand.

14. A non-transitory computer-readable storage medium storing instructions that, when executed by a computer process, cause a computing device configuring an automated booking service platform with a third data store to:
receive a first set of data carrying information on properties of one or more, each event having a temporal factor;
assign metadata tags to each of the one or more historic events into metadata tags to characterise the historic events using the metadata tags;
receive a second set of data carrying information on a demand for one or more, the demand for services having a temporal factor;
filter the data carrying information on demand for one or more services by performing grouping operations to thereby distinguish ordinary demand from extra-ordinary demand and to identify extra-ordinary demand;
implementing a first machine learning process to determine a correlation between metadata tags, or combinations of metadata tags, and extra-ordinary demand in an event data set, then quantifying the impact of the correlation, the impact having a binary characterisation, wherein the metadata tags are associated with the events in the event data set with the extra-ordinary demand;
generate a third data set carrying information on a grouping of metadata tags, or combinations of metadata tags, associated with events having impact quantified above a threshold, wherein the third dataset is operable for predictive determinations of future event impact on service demand; and
implement a second machine learning process to determine a prediction model relating metadata tags, or combinations of metadata tags of the third data set to extra-ordinary demand, thereby establishing a correlation between the events and associated metadata in the third data set;
storing the third dataset in a database.
